(19) United States
(12) Patent Application Publication
(10) Pub. No.: US 2026/0261777 A1
(43) Pub. Date: Sep. 3, 2026

(54) POWER SYSTEM FOR CMOS IMAGE SENSOR, CMOS IMAGE SENSOR, AND SENSING CIRCUIT

(71) Applicant: NOVATEK MICROELECTRONICS CORP., Hsnchu (CN)

(72) Inventors: Lo-Wei Huang, Hsinchu (CN); Su-Wei Lien, Hsinchu (CN); Cho-Hsuan Jhang, Hsinchu (CN); Hong-Chu Chen, Hsinchu (CN)

(21) Appl. No.: 19/554,246

(22) Filed: Mar. 2, 2026

Related U.S. Application Data
(60) Provisional application No. 63/766,353, filed on Mar. 3, 2025.

(30) Foreign Application Priority Data
Feb. 24, 2026 (CN) 202610220562.X

(51) Int. Cl. H04N 25/709; H04N 25/76

(52) U.S. Cl. CPC H04N 25/709; H04N 25/7795

(57) ABSTRACT

A power system of a Complementary Metal Oxide Semiconductor (CMOS) image sensor, a CMOS image sensor and a sensing circuit are provided. The power system includes: a first-stage voltage conversion circuit configured to convert an input voltage into a first voltage in response to a pulse signal; a second-stage voltage conversion circuit configured to convert the first voltage into one or more second voltages for providing voltages required for operations of the CMOS image sensor; and a voltage detection circuit configured to generate a voltage detection signal based on the first voltage, where the voltage detection signal is used in a pulse control circuit to generate the pulse signal.

### CROSS-REFERENCE TO RELATED APPLICATIONS

The present disclosure claims priority to and the benefit of U.S. Provisional Application No. 63/766,353, filed March 3, 2025, and Chinese Application No. 202610220562X filed on February 24, 2026, which are incorporated herein by reference for all purposes

### TECHNICAL FIELD

The present disclosure relates generally to the field of sensor technology, and more particularly, to a power system for a Complementary Metal Oxide Semiconductor (CMOS) image sensor, a CMOS image sensor, and a sensing circuit.

### BACKGROUND

The CMOS image sensor is a solid-state image sensor whose core structure is a two-dimensional pixel array integrated on a semiconductor substrate. Each pixel circuit in the pixel array contains a photoelectric conversion element (usually a photodiode). When photons illuminate a pixel circuit, the photoelectric conversion element generates a charge proportional to a respective light intensity, and converts it into an electrical signal, which is then read row by row or randomly by a readout circuit, and finally synthesized into a complete digital image.

The CMOS image sensor offers several key advantages that it can be fabricated in standard CMOS processes, with low production costs; it is easy to integrate photoelectric sensing, signal amplification, Analog/Digital (A/D) conversion and image processing circuits into a single chip, which greatly promotes the miniaturization of devices; at the same time, it has random access capability, supports flexible window scanning and high-speed reading; and it also consumes low power, making it ideal for battery-powered portable devices.

For this reason, the CMOS image sensor has been widely used in mobile phone cameras, security surveillance, automotive vision, machine vision, robot navigation, medical imaging, aerospace and other fields, and continues to move toward high resolution, high dynamic range, and low illumination sensitivity, which has become the mainstream choice for today’s digital imaging technology.

Generally, multiple pixel driving signals are required for controlling the pixel array of the CMOS image sensor to achieve pixel circuit selection, reset, driving, etc. These pixel driving signals all need to be converted from the input voltage. Therefore, in order to ensure the normal operation of the CMOS image sensor, a power system that can provide stable output voltage(s) for generating the pixel driving signals is needed.

### SUMMARY

In accordance with an aspect of the present disclosure, there is provided a power system for a Complementary Metal Oxide Semiconductor (CMOS) image sensor, including: a first-stage voltage conversion circuit configured to convert an input voltage into a first voltage in response to a pulse signal; a second-stage voltage conversion circuit configured to convert the first voltage into one or more second voltages for providing voltages required for operations of the CMOS image sensor; and a voltage detection circuit configured to generate a voltage detection signal based on the first voltage; wherein the voltage detection signal is used in a pulse control circuit to generate the pulse signal.

According to another aspect of the present disclosure, there is also provided a Complementary Metal Oxide Semiconductor (CMOS) image sensor including: a pixel array including a plurality of pixel circuits arranged in an array; a pulse control circuit configured to generate, according to a voltage detection signal, clock signals for a decoding process; a decoding circuit configured to decode based on the clock signals; and a power system as described above, configured to provide the voltage detection signal to the pulse control circuit and to provide the one or more second voltages to the decoding circuit, wherein the decoding circuit generates, based on a decoding result and using the one or more second voltages, pixel driving signals for controlling the pixel circuits.

According to another aspect of the present disclosure, there is also provided a sensing circuit for a Complementary Metal Oxide Semiconductor (CMOS) pixel array including a plurality of pixel circuits arranged in an array, the sensing circuit including: a pulse control circuit configured to generate, according to a voltage detection signal, clock signals for a decoding process; a decoding circuit configured to decode based on the clock signals; and a power system as described above, configured to provide the voltage detection signal to the pulse control circuit and to provide the one or more second voltages to the decoding circuit, wherein the decoding circuit generates, based on a decoding result and using the one or more second voltages, pixel driving signals for controlling the pixel circuits.

Using the improved CMOS image sensor according to the embodiment of the present disclosure, a voltage detection circuit is used to detect the first voltage output by the first-stage voltage conversion circuit in the power system, and based on the result of comparing the first voltage with one or more voltage thresholds, a voltage detection signal is generated and output to the pulse control circuit to adjust the frequency and/or duty cycle of the pulse signal, thereby changing the potential of the first voltage. Therefore, when the pixel circuit is sunk by loads too deeply in a specific scene such as high load power, the voltage detection signal can be used to control the pulse control circuit to generate the pulse signal with a higher frequency and/or an adjusted duty cycle to be provided to the power system, for ensuring the potential of the first voltage without continuously maintaining a high frequency or maintaining a duty cycle that keeps the potential of the first voltage high. In addition, the power system of the present disclosure includes two stages of voltage conversion circuits, which can have a higher Power Supply Rejection Ratio (PSRR) of the pixel voltage output by the pixel circuit to the input voltage, and can adaptively adjust the timing according to scene changes to achieve optimized low power consumption characteristics.

### BRIEF DESCRIPTION OF DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic structural diagram of a CMOS image sensor according to an embodiment of the present disclosure.

FIGS. 2A to 2C illustrate several example structures of a pixel circuit according to an embodiment of the present disclosure.

FIGS. 3A to 3B illustrate a clock frequency setting scheme in a high load power scene.

FIG. 4 illustrates a schematic structural diagram of an improved CMOS image sensor according to an embodiment of the present disclosure.

FIG. 5 shows a schematic diagram of changes of the voltage detection signal Spos and the pulse signal PULSEpos as the first voltage Vpos changes, in the presence of only one preset voltage threshold Vth0.

FIG. 6 shows a schematic diagram of changes in the voltage detection signal Spos and the pulse signal PULSEpos as the first voltage Vpos changes, in the presence of the first voltage threshold Vth01 and the second voltage threshold Vth02.

FIG. 7 shows a schematic diagram of changes in the voltage detection signal Spos and the pulse signal PULSEpos as the first voltage Vpos changes, in the presence of the first voltage threshold Vth1, the second voltage threshold Vth2 and the third voltage threshold Vth3.

FIG. 8 shows a schematic structural diagram of a sensing circuit according to an embodiment of the present disclosure.

### DETAILED DESCRIPTION

It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless otherwise limited, the term “connected” and variations thereof herein are used broadly and encompass direct and indirect connections, and may include electrical or physical connections.

Throughout this disclosure, ordinal numbers (e.g., first, second, third, etc.) may be used as an adjective for an element (i.e., any noun in this disclosure). The use of ordinal numbers is not intended to imply or create any particular ordering of the elements nor to limit any element to only a single element unless expressly disclosed, such as by use of the terms “before,” “after,” “single,” and other such terms. Rather, the use of ordinal numbers is to distinguish between elements. For example, a first element is distinct from a second element, and the first element may include more than one element and follow (or precede) a second element per the order of elements.

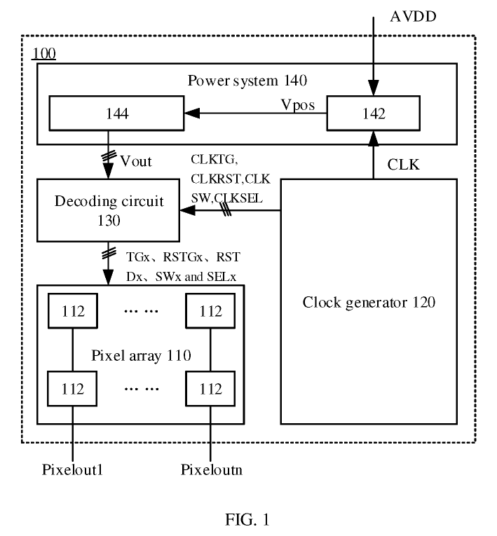

FIG. 1 illustrates a schematic structural diagram of a CMOS image sensor according to an embodiment of the present disclosure.

As shown in FIG. 1, the CMOS image sensor 100 includes a pixel array 110, a clock generator 120, a decoding circuit 130 and a power system 140.

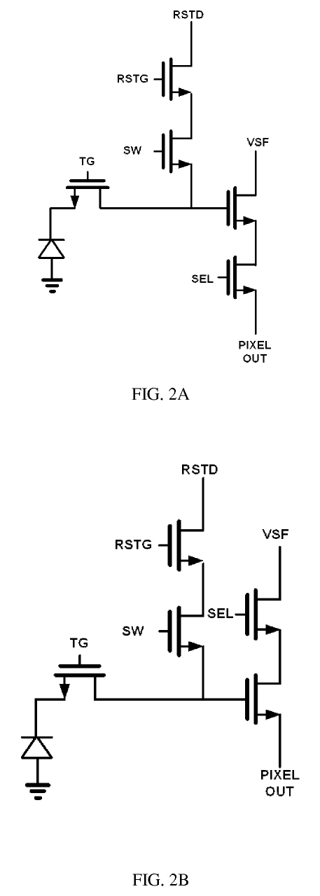

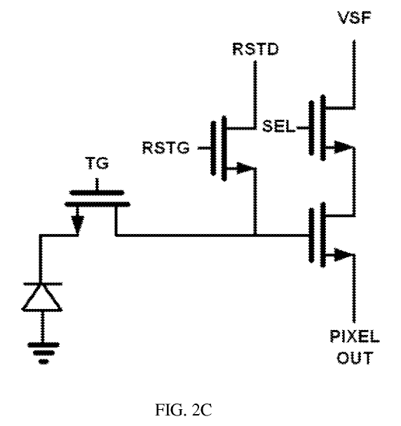

The pixel array 110 may include a plurality of pixel circuits 112 arranged in an array. Each pixel circuit 112 may adopt various circuit structures well known in the art. For example, FIGS. 2A to 2C each illustrate an example structure of the pixel circuit 112, but the present disclosure is not limited thereto.

The clock generator 120 may be configured to generate various clock signals required when the CMOS image sensor 100 operates normally, including but not limited to clock signals required for selection, resetting, and driving of the pixel circuits 112, as well as clock signals required by other modules (e.g., the power system 140) included in the CMOS image sensor 100, etc., where the clock signals required by the pixel array 110 may be determined by the structure of pixel circuits 112 in the pixel array 110.

The power system 140 may generate one or more converted voltages based on an external input voltage AVDD for use by the decoding circuit 130, and the decoding circuit 130 may be configured to decode based on the clock signals generated by the clock generator 120 which are required for driving the pixel array 110, so that one or more converted voltages generated by the power system 140 can be used by the decoding circuit 130 to output pixel driving signals for controlling the pixel circuits 112.

More specifically, for example, each pixel circuit 112 of the pixel array 110 may adopt a circuit structure as shown in any one of FIGS. 2A to 2C, and therefore in this case, each pixel circuit 112 needs to receive multiple pixel driving signals so that a respective electrical signal (Pixelout1,..., Pixeloutn) can be read out from the pixel circuit 112. For example, the pixel driving signals TGx, RSTGx, RSTDx, SWx, and SELx shown in FIG. 1 can be used for the x-th pixel circuit 112. Therefore, the decoding circuit 130 needs to receive multiple voltages corresponding to the pixel driving signals, and voltage amplitudes of the output multiple pixel driving signals are determined by the potentials of the multiple voltages received by the decoding circuit 130.

As shown in FIG. 1, the power system 140 may convert the external input voltage AVDD into multiple converted voltages, which may then be provided to the decoding circuit 130 or other circuit modules (not shown). For example, the power system 140 may include a first-stage voltage conversion circuit 142 and a second-stage voltage conversion circuit 144.

The first-stage voltage conversion circuit 142 may be a charge pump circuit (for example, composed of diodes and capacitors), and boosts the input voltage in response to a clock signal as one example of the pulse signal. For example, the charge pump circuit boosts the input voltage AVDD of 2.8V to an output voltage of 3.3V. The output voltage of the charge pump circuit increases as the frequency of the clock signal increases. Alternatively, the first-stage voltage conversion circuit 142 may be a direct-current to direct-current (DC-DC) converter (e.g., using a buck topology or a boost topology, etc.) and needs to operate under the control of a pulse signal such as a pulse-width modulation (PWM) signal or a pulse-frequency modulation (PFM) signal or the like. Therefore, the clock generator 120 can also generate the pulse signal for controlling the first-stage voltage conversion circuit 142, so that the first-stage voltage conversion circuit 142 converts the input voltage AVDD (for example, 2.8V) into the first voltage Vpos (for example, 3.3V) in response to the pulse signal. Then, the second-stage voltage conversion circuit 144 may be configured to convert the first voltage Vpos into one or more second voltages Vout, and the one or more second voltages Vout are used to provide voltages required by the CMOS image sensor for normal operation, including, for example, multiple voltages required by the decoding circuit 130 for generating the pixel driving signals. In an embodiment, the second-stage voltage conversion circuit 144 may employ one or more linear regulators such as Low Dropout Regulators (LDOs), thereby having extremely low self-noise and a high PSRR. Of course, the second-stage voltage conversion circuit 144 may also be a single-input single-output or multi-output DC-DC converter.

For the power system in FIG. 1, in order to provide a voltage with a higher potential than that of the input voltage AVDD to the pixel circuits 112, and in order to resist power noise from the input voltage AVDD, the power system in FIG. 1 can adopt an architecture such as the LDO and a charge pump circuit (or other two-stage DC-DC conversion circuit) to improve the power supply rejection ratio (PSRR) of the pixel voltage (Pixelout) output by the pixel circuit 112 to the input voltage AVDD, but the current conversion efficiency of the charge pump circuit (or other boost DC-DC circuit) in the power system 140 in the CMOS image sensor 100 will lead to an increase in overall power consumption.

Therefore, in order to meet the low power consumption requirements of the CMOS image sensor 100 (for example, when it is applied to Internet of Things applications), some designers adjust the pulse signal when designing the architecture of the CMOS image sensor 100, such as reducing the frequency and/or duty cycle of the pulse signal PULSEpos provided to the power system 140 (assuming that the smaller the duty cycle, the lower potential of the output voltage (which can also be understood as the smaller the output power) of the first-stage voltage conversion circuit 142) to achieve low power consumption. However, in a specific scene, such as a high load power scene when a display picture with a higher brightness needs to be displayed, the pixel circuits 112 may be sunk by loads too deeply, thereby causing the decrease of the first voltage Vpos, that is, the first voltage Vpos output by the first-stage voltage conversion circuit 142 (charge pump circuit or other boost DC-DC circuit) is insufficient, resulting in poor performance of the CMOS image sensor, such as failure when presenting the display picture. However, if the frequency of the pulse signal PULSEpos is selected to be high for this specific scene that may not be so frequent, it will waste power consumption.

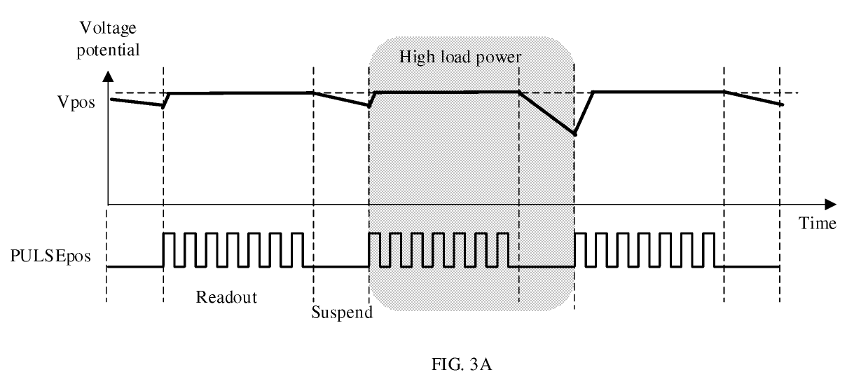

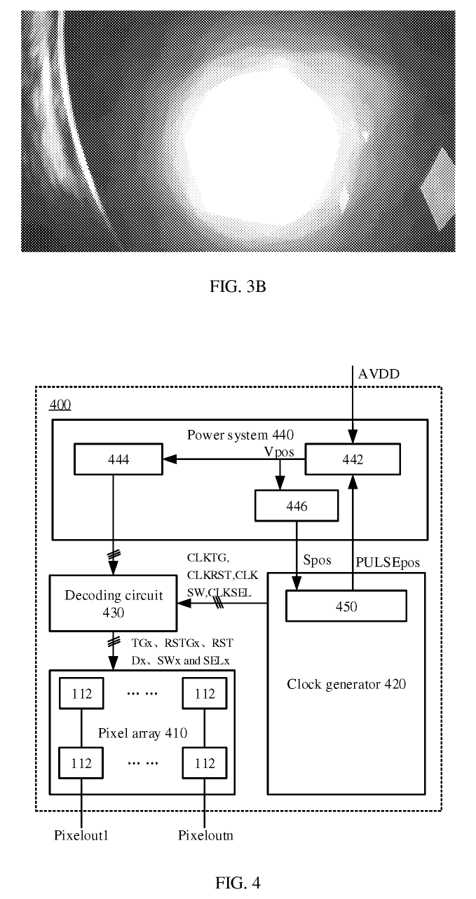

FIGS. 3A to 3B illustrate a clock frequency setting scheme in the high load power scene.

Generally, as shown in FIG. 3A, the clock generator 120 can divide time domain into a first period and a second period alternately. This division can be designed based on the frame rate (FPS), pixel size, transmission speed, etc. according to user requirements, and will not change once the design of the CMOS image sensor is complete. In each first period, the CMOS image sensor 400 is in an active mode for readout operation, so the first period may also be called a readout period or an active period (shown as Readout in FIG. 3A). In each second period, the CMOS image sensor 400 is in a sleep mode so that no readout operation is performed, so the second period may also be called a sleep period or a suspension period (shown as Suspend in FIG. 3A).

In FIG. 3A, the clock generator 120 outputs the clock signal PULSEpos with a predetermined frequency during an ordinal first readout period, for controlling the first-stage voltage conversion circuit 142 in the power system 140 to output the first voltage Vpos, and during an ordinal second sleep period after the ordinal first readout period, no clock signal is output, so that the first-stage voltage conversion circuit 142 continues to provide the first voltage Vpos based on the stored electric energy at the end of the ordinal first readout period. During the ordinal second sleep period, the potential of the first voltage Vpos output by the first-stage voltage conversion circuit 142 will gradually decrease until a new readout period arrives and a new clock signal is received.

As mentioned above, sometimes the load power will be higher, for example, when the CMOS image sensor 400 is required to present the display picture as shown in FIG. 3B, because some regions of the display picture have higher brightness, the pixel circuits 112 need to output a higher pixel voltage, that is, the load sinks too deeply. In order to ensure the load power requirements under different scenes, the frequency of the clock signal PULSEpos provided to the power system 140 can be maintained at a high frequency, like the clock signal PULSEpos with a high frequency in each readout period as shown in FIG. 3A.

During each readout period as shown in FIG. 3A, the potential of the first voltage Vpos output by the first-stage voltage conversion circuit 142 will stabilize at an appropriate value due to the clock signal PULSEpos with a high frequency, and during the sleep period under high load power, because there is no clock signal PULSEpos, the potential of the first voltage Vpos will quickly decrease to a low value, but in the next readout period, the potential of the first voltage Vpos can recover to a value that enables the CMOS image sensor 100 to operate normally in time. Therefore, the performance of the CMOS image sensor 100 can be ensured, such as normal presentation of the current display picture can be ensured.

However, in the embodiment of FIG. 3A, even in a normal scene that is not a high load power scene, the frequency of the clock signal PULSEpos is still high, so power consumption is wasted.

In addition, in some embodiments, a power system that does not require a clock signal may be considered. For example, some CMOS image sensors 100 may sacrifice the PSRR of the pixel voltage output by the pixel circuits 112 to the input voltage AVDD, and use only linear regulators such as LDOs to resist power noise. Other CMOS image sensors rely on external large capacitors or external linear regulators, but this will increase the cost of external passive components.

Therefore, there is a need for a power system for a CMOS image sensor that can not only provide a voltage with a higher potential than that of the input voltage AVDD to the pixel circuits, resist power noise from the input voltage AVDD, but also have lower power consumption, while ensuring normal operation under high load power scenes.

FIG. 4 illustrates a schematic structural diagram of an improved CMOS image sensor according to an embodiment of the present disclosure. The CMOS image sensor can achieve low power consumption while ensuring normal presentation of display pictures in high load power scenes, by adaptively adjusting the frequency and/or duty cycle of the clock signal.

For example, the CMOS image sensor 400 shown in FIG. 4 includes a pixel array 410, a clock generator 420, a decoding circuit 430, and a power system 440. More details of the pixel array 410 may be referred to the foregoing description with reference to FIG. 1 and FIGS. 2A to 2C, and more details of the decoding circuit 430 may be referred to the foregoing description with reference to FIG. 1.

In FIG. 4, the power system 440 may include a first-stage voltage conversion circuit 442, a second-stage voltage conversion circuit 444, and a voltage detection circuit 446.

The first-stage voltage conversion circuit 442, as previously described with reference to FIG. 1, may be configured to convert the input voltage AVDD (e.g., may have a potential of 2.8V) into a first voltage (e.g., may have a potential of 3.3V) in response to a pulse signal. Similarly, the first-stage voltage conversion circuit 442 may adopt the architecture of a charge pump circuit or other DC-DC converters such as a buck converter, or boost converter, etc. according to whether a step-up or step-down operation for the input voltage is required. For example, when the first-stage voltage conversion circuit 442 includes a charge pump circuit, the pulse signal PULSEpos may be a clock signal for voltage control, and as the frequency of the clock signal increases, the potential of the first voltage Vpos output by the first-stage voltage conversion circuit 442 increases. When the first-stage voltage conversion circuit 442 is a DC-DC converter, the pulse signal PULSEpos can be a pulse width modulation (PWM) signal or a pulse frequency modulation (PFM) signal or the like, and as the frequency of the pulse signal increases and/or as the duty cycle changes (the relationship between the duty cycle and the potential of the first voltage Vpos is determined by the topology of the DC-DC converter), the potential of the first voltage Vpos output by the first-stage voltage conversion circuit 442 can increase.

The second-stage voltage conversion circuit 444 may also be configured to convert the first voltage Vpos output by the first-stage voltage conversion circuit 442 into one or more second voltages, and the one or more second voltages are used for providing voltages required for operations of the CMOS image sensor 400, as described above with reference to FIG. 1. For example, the one or more second voltages may include multiple voltages required by the decoding circuit 430 for generating the pixel driving signals. In one embodiment, the second-stage voltage conversion circuit 444 may include one or more linear regulators such as LDOs, thereby having extremely low self-noise and high PSRR, or the second-stage voltage conversion circuit 144 may also be a single-input single-output or multi-output DC-DC converter.

The voltage detection circuit 446 is a new part compared to the CMOS image sensor 100 shown in FIG. 1. It may be configured to generate the voltage detection signal Spos based on the first voltage Vpos, the voltage detection signal Spos is used by the pulse control circuit 450 to generate the pulse signal PULSEpos, and different values of the voltage detection signal Spos correspond to different frequencies and/or different duty cycles of the pulse signal.

Optionally, as shown in FIG. 4, the pulse control circuit 450 may be included in the clock generator 420, or may be independent of the clock generator 420, and the present disclosure does not limit this. The pulse control circuit 450 may also be included in the power system 440, or may be independent of the power system 440.

For example, usually in order to meet the requirements of low power consumption, the frequency of the clock signal during the readout period is lower and/or the duty cycle is small (assuming that the larger the duty cycle, the higher the potential of the first voltage output by the first-stage voltage conversion circuit 442), but there may be cases where the pixel circuit is sunk too deeply due to the high load power, which will cause the first voltage Vpos to not stabilize at a suitable potential, resulting in poor performance of the CMOS image sensor, such as failure when presenting a display picture. Therefore, when the voltage detection circuit 446 detects that the potential of the first voltage Vpos is low, it can indicate this situation by generating the voltage detection signal Spos, so that the first voltage can recover to an appropriate potential as quickly as possible. Because the first voltage is generated by the first-stage voltage conversion circuit 442 based on the pulse signal, the potential of the first voltage can be increased by adjusting the frequency and/or duty cycle of the pulse signal.

For example, the voltage detection circuit 446 may generate the voltage detection signal Spos based on a comparison result of the potential of the first voltage Vpos and at least one preset voltage threshold.

For example, in some embodiments, the frequency and/or duty cycle of the pulse signal can be adjusted according to the value of the power detection signal Spos, and different values of the voltage detection signal Spos correspond to different frequencies and/or duty cycles.

Therefore, when there is only one preset voltage threshold Vth0, the value of the voltage detection signal Spos may be 0 or 1. For example, the voltage detection circuit 446 may employ a comparator circuit, where the feedback voltage characterizing the first voltage Vpos and the preset voltage threshold Vth0 are provided to two inputs of the comparator circuit, and the output of the comparator outputs 0 or 1 to indicate the voltage detection signal Spos.

In this case, the voltage detection circuit 446 may be configured to generate the voltage detection signal Spos having a first value when the potential of the first voltage Vpos output by the first-stage voltage conversion circuit 442 is greater than or equal to the preset voltage threshold Vth0, and to generate the voltage detection signal Spos having a second value when the potential of the first voltage Vpos is less than the preset voltage threshold Vth0, where compared to the first value, the second value corresponds to a higher frequency of the pulse signal, and/or the second value corresponds to a larger duty cycle of the pulse signal (assuming that the larger the duty cycle, the higher the potential of the first voltage output by the first-stage voltage conversion circuit 442).

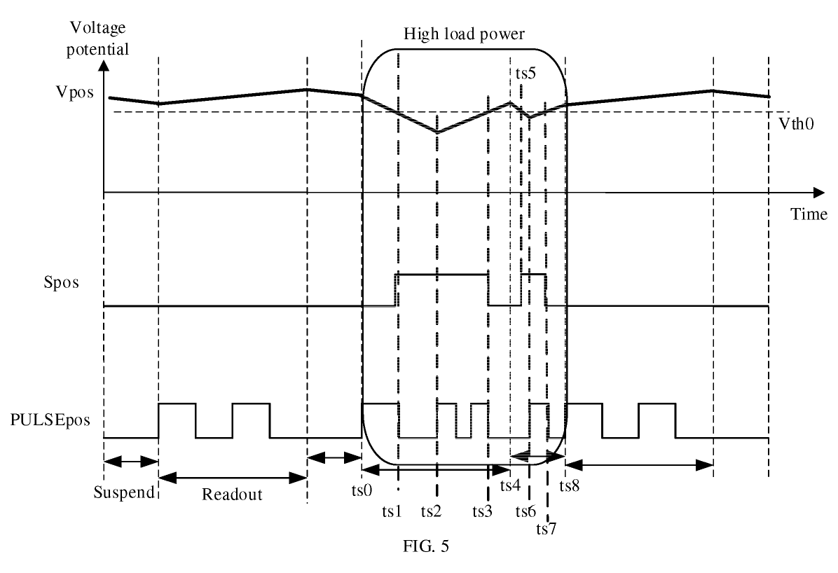

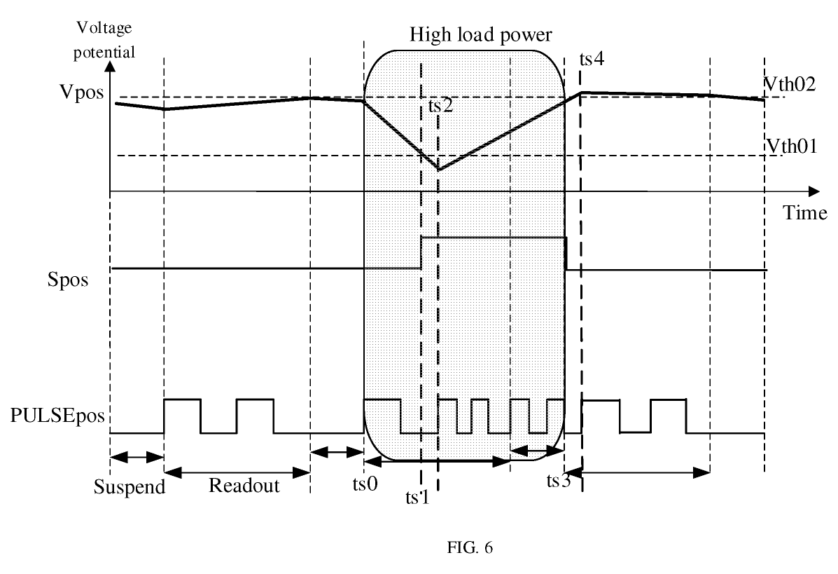

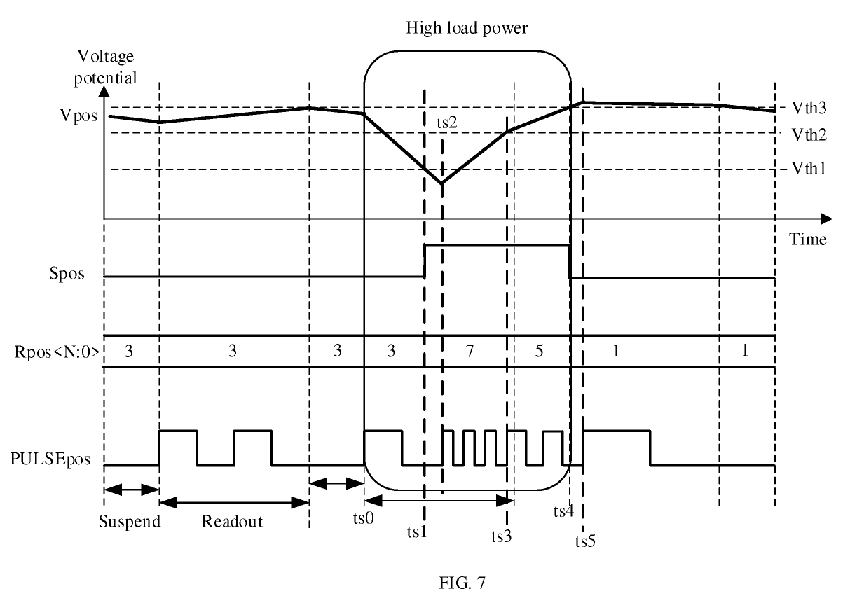

FIG. 5 shows a schematic diagram of changes in the voltage detection signal Spos and the pulse signal PULSEpos as the first voltage Vpos changes in the presence of only one preset voltage threshold Vth0. It should be understood that in the embodiments described in FIG. 5 and following FIG. 6 and FIG. 7, pulse characteristics such as the number of pulses and pulse width are shown for ease of understanding, but do not limit the content of the present disclosure to these embodiments.

As shown in FIG. 5, similarly, the clock generator 420 or the pulse control circuit 450 can divide time domain into a first period and a second period alternately. This division can be designed based on the frame rate (FPS), pixel size, transmission speed, etc. according to user requirements, and will not change once the design of the CMOS image sensor is complete. In each first period, the CMOS image sensor 400 is in an active mode for readout operation, so the first period may also be called a readout period or an active period (shown as Readout in FIG. 5). In each second period, the CMOS image sensor 400 is in a sleep mode so that no readout operation is performed, so the second period may also be called a sleep period or a suspension period (shown as Suspend in FIG. 5).

Because the first-stage voltage conversion circuit 442 needs to output the first voltage Vpos during the readout period, the pulse control circuit 450 outputs the pulse signal PULSEpos for the first-stage voltage conversion circuit 442 to output the first voltage Vpos. In the ordinal first Readout period (Readout) shown in FIG. 5, the load power requirement is not high, that is, it is not in a high load power scene, the first voltage Vpos may fluctuate slightly, for example, the potential of the first voltage Vpos may increase slowly based on the driving of the pulse signal PULSEpos, but it is always greater than the preset voltage threshold Vth0, so the voltage detection signal Spos remains at the first value (e.g., 0). The pulse signal PULSEpos output by the pulse control circuit 450 is a clock signal as an example in this embodiment, so the clock signal has a first frequency corresponding to the first value (0). Of course, in the context of the present disclosure, although adjusting the frequency is taken as an example, because the pulse signal may be a PWM signal or PFM signal, it is also possible to adjust the duty cycle, and in the case where the first-stage voltage conversion circuit 442 is a DC-DC converter, the duty cycle can be adjusted according to the topology of the DC-DC converter for adjusting the first voltage Vpos.

Next, in the ordinal second sleep period (Suspend) after the ordinal first readout period (Readout) shown in the figure, the pulse control circuit 450 does not output a pulse signal. During this sleep period (Suspend), the first voltage Vpos output by the first-stage voltage conversion circuit 442 will decrease slightly. However, because the load power requirement is not high at this time, the decrease magnitude is not large, so the first voltage Vpos is still greater than the preset voltage threshold Vth0, and the voltage detection signal Spos still has the first value.

Then, at time ts0, the ordinal second readout period (Readout) starts, and correspondingly, the period of the high load power scene starts. Typically, the load power is associated with parameters of the display picture of each display frame, and in each readout period, readout operation is performed on one display picture, so the period of the high load power scene can span one or more readout periods. During the first sub-period ts0-ts1, even if the pulse control circuit 450 is still outputting the pulse signal, because the load power requirements become higher (for example, the display picture with higher brightness needs to be displayed), but the pulse signal still has the previous lower frequency, then the potential of the first voltage Vpos output by the first-stage voltage conversion circuit 442 keeps decreasing. When the potential of the first voltage Vpos decreases to the preset voltage threshold Vth0 at time ts1, the voltage detection signal Spos switches to the second value (e.g., 1).

In order to facilitate timing control, when the pulse control circuit 450 determines that the frequency of the pulse signal PULSEpos needs to be changed based on the voltage detection signal Vpos, the pulse control circuit 450 changes the frequency of the pulse signal PULSEpos only after a current pulse cycle of the pulse signal PULSEpos ends. Therefore, as shown in FIG. 5, during the second sub-period ts1-ts2 of the ordinal second readout period, even if the potential of the first voltage Vpos has decreased below the preset voltage threshold Vth0, because the current pulse cycle has not yet ended, the pulse control circuit 450 does not generate the pulse signal with a different frequency until the current pulse cycle ends at time ts2.

During the third sub-period ts2-ts3 of the ordinal second readout period (Readout), in response to the potential of the first voltage Vpos having decreased below the preset voltage threshold Vth0, the voltage detection signal Spos remains at the second value, and the pulse signal PULSEpos has a second frequency corresponding to the second value, where the second frequency is greater than the first frequency of the pulse signal in the ordinal first readout period (Readout). Because the frequency of the pulse signal PULSEpos increases, the potential of the first voltage Vpos increases, but considering the effect of the load, it gradually increases, and increases to the preset voltage threshold Vth0 at time ts3. At this time, the voltage detection signal Spos switches again to the first value (0).

Similarly, at time ts3, the current pulse cycle of the pulse signal has not ended, and at time ts4, the current pulse cycle ends. During the fourth sub-period ts3-ts4 of the ordinal second readout period (Readout), the potential of the first voltage Vpos continues to increase and is still greater than the preset voltage threshold Vth0, so the voltage detection signal Spos remains at the first value (0).

At time ts4, the second readout period (Readout) ends and the ordinal third sleep period (Suspend) starts. Because the voltage detection signal Spos still remains at the first value (0) at this time, the pulse control circuit 450 does not output the pulse signal, so the potential of the first voltage Vpos starts to decrease again until it decreases to the preset voltage threshold Vth0 at time ts5, then the voltage detection signal Spos switches to the second value (1).

In order to facilitate the timing design, the pulse cycle still needs to be corresponded, so during the sub-period ts5-ts6 of the ordinal third sleep period (Suspend), even if the voltage detection signal Spos switches to the second value (1), in order to correspond to the pulse cycle of the pulse signal PULSEpos having the second frequency, the pulse signal PULSEpos is still not generated during this sub-period, so the potential of the first voltage Vpos continues to decrease until a pulse rising edge can be generated corresponding to the pulse cycle of the pulse signal PULSEpos having the second frequency at time ts6, so that during the sub-period ts6-ts7, the pulse signal PULSEpos has the second frequency corresponding to the second value (1), and the potential of the first voltage Vpos increases until the potential of the first voltage Vpos reaches the preset voltage threshold Vth0 at time ts7, and the voltage detection signal Spos switches to the first value (0) again.

Similarly, because the current pulse cycle has not ended at time ts7, during the sub-period ts7-ts8, the potential of the first voltage Vpos continues to increase until the current pulse cycle ends at time ts8. Because it is no longer in the high load power scene after time ts8, for example, the presentation of the display picture having higher brightness is ended, the frequency of the pulse signal returns to the lower first frequency corresponding to the first value (0), and then the pulse control circuit 450 continues to output a pulse signal with a corresponding frequency according to the detection result of the first voltage Vpos.

Of course, the high load power scene may last for a longer duration, such as involving multiple consecutive display pictures. During this duration, the frequency and/or duty cycle of the pulse signal can also be changed in conjunction with the value of the voltage detection signal according to the above process.

In addition, in some embodiments, in order to avoid possible frequent fluctuations of the first voltage Vpos near the preset voltage threshold Vth0, so as to avoid possible frequent fluctuations of the voltage detection signal Spos between the first value (0) and the second value (1), the principle of hysteresis comparison can be considered. In this embodiment, the voltage detection circuit 446 generates the voltage detection signal Spos based on a first voltage threshold Vth01 and a second voltage threshold Vth02.

For example, the voltage detection circuit 446 may employ a hysteresis comparator circuit, where a feedback voltage characterizing the first voltage Vpos and a reference preset voltage threshold used to generate the first voltage threshold Vth01 and the second voltage threshold Vth02 are provided to two inputs of the comparator circuit, and the output of the comparator outputs 0 or 1 to indicate the voltage detection signal Spos. The first voltage threshold is less than the second voltage threshold.

In this case, the voltage detection circuit 446 may be configured to: when the first voltage Vpos is not in an increasing process starting from a potential smaller than the first voltage threshold Vth01 and the potential of the first voltage Vpos is between the first voltage threshold Vth01 and the second voltage threshold Vth02, generate the voltage detection signal Spos having the first value; when the potential of the first voltage Vpos is less than the first voltage threshold Vth01, generate the voltage detection signal Spos having a second value; when the first voltage Vpos is in an increasing process from a potential less than the first voltage threshold Vth01 and the potential of the first voltage Vpos is greater than or equal to the first voltage threshold Vth01 and less than the second voltage threshold, generate the voltage detection signal Spos having the second value; and when the potential of the first voltage Vpos is greater than or equal to the second voltage threshold, generate the voltage detection signal Spos having the first value.

Furthermore, FIG. 6 shows a schematic diagram of changes in the voltage detection signal Spos and the pulse signal PULSEpos as the first voltage Vpos changes in the presence of the first voltage threshold Vth01 and the second voltage threshold Vth02.

As shown in FIG. 6, the clock generator 420 or the pulse control circuit 450 may divide time domain into a first period (readout period or active period) and a second period (sleep period) alternately.

The ordinal first readout period (Readout) and the ordinal second sleep period (Suspend) after the ordinal first readout period shown in FIG. 6 are similar to those described above with reference to FIG. 5, except that the preset voltage threshold Vth0 is replaced by the first voltage threshold Vth01, and the description will not be repeated here. Because during the ordinal first readout period, the first voltage Vpos is not in an increasing process starting from a potential smaller than the first voltage threshold Vth01 and fluctuates between the first voltage threshold Vth01 and the second voltage threshold Vth02, the voltage detection signal Spos has the first value, the pulse signal PULSEpos output by the pulse control circuit 450 has a first frequency corresponding to the first value (0), and during the ordinal second sleep period (Suspend), the voltage detection signal Spos has the first value, and the pulse control circuit 450 does not output the pulse signal.

Then, the ordinal second readout period (Readout) starts at time ts0, and the first sub-period ts0-ts1 of the ordinal second readout period (Readout) is also similar to that described above with reference to FIG. 5, except that the preset voltage threshold Vth0 is replaced by the first voltage threshold Vth01, and the description will not be repeated here.

During the second sub-period ts1-ts2 of the ordinal second readout period (Readout), the potential of the first voltage Vpos has decreased below the first voltage threshold Vth01, the voltage detection signal Spos switches to the second value, but because the current pulse cycle has not ended yet, the pulse control circuit 450 does not generate the pulse signal with a different frequency until the current pulse cycle ends at time ts2.

During the third sub-period ts2-ts3, at time ts2, in response to the first voltage Vpos having decreased below the first voltage threshold Vth01, and because the voltage detection signal Spos still remains at the second value and the current pulse cycle has ended, the pulse signal PULSEpos output by the pulse control circuit 450 has a second frequency corresponding to the second value, where the second frequency is greater than the first frequency of the pulse signal in the ordinal first readout period (Readout). Because the frequency of the pulse signal PULSEpos increases, the potential of the first voltage Vpos gradually increases, and increases to the second voltage threshold Vth02 at time ts3, and then the voltage detection signal Spos switches to the first value (0) again.

Similarly, at time ts3, the current pulse cycle of the pulse signal has not ended, and the current pulse cycle ends at time ts4, so, during the sub-period ts3-ts4, the potential of the first voltage Vpos is still greater than the second voltage threshold Vth02, the voltage detection signal Spos remains at the first value (0), and the pulse signal PULSEpos output by the pulse control circuit 450 has the first frequency corresponding to the first value from time t4.

Assuming that the high load power scene ends at time ts3, for example, the presentation of the display picture having higher brightness of the current frame is completed, the pulse control circuit 450 continues to output the pulse signal with a corresponding frequency according to the detection result of the first voltage Vpos.

In the embodiment described with reference to FIG. 6, the first frequency corresponding to the first value of the voltage detection signal Spos is fixed, and the second frequency corresponding to the second value of the voltage detection signal Spos is also fixed, so the circuit design can be facilitated. Similarly, the first duty cycle corresponding to the first value of the voltage detection signal Spos may also be fixed, and the second duty cycle corresponding to the second value of the voltage detection signal Spos may also be fixed.

Therefore, combined with the embodiments shown in FIG. 5 and FIG. 6, it can be seen that when the voltage detection signal Spos remains at the first value during the readout period (Readout period), it means that the first voltage Vpos generated by the first-stage voltage generation circuit 442 based on the current pulse signal is sufficient for the current load requirements, so there is no need to adjust the pulse signal, and the pulse control circuit 450 outputs the pulse signal with a low frequency/small duty cycle (assuming that the larger the duty cycle, the higher the potential of the first voltage) during the readout period to meet the requirements of low load power consumption, as described above in the ordinal first readout period (Readout). Next, if the voltage detection signal Spos remains at the first value during the sleep period (sleep period), it means that even if the pulse control circuit 450 does not output the pulse signal, the first voltage Vpos is sufficient for the current load requirements, so there is no need to adjust the pulse signal, so the pulse control circuit 450 does not output the pulse signal during the sleep period, such as in the ordinal second sleep period (Suspend) described above.

If the voltage detection signal Spos switches from the first value (0) to the second value (1) at a certain moment in a readout period, it means that the first voltage Vpos generated by the first-stage voltage generation circuit 442 based on the current pulse signal cannot meet the current load requirements, so the pulse signal needs to be adjusted. Therefore, the pulse control circuit 450 outputs the pulse signal with a higher frequency/larger duty cycle at an appropriate pulse generation timing after this moment in the readout period (for example, at the end of the current pulse cycle) to increase the first voltage Vpos to meet the current higher load requirements, as in the ordinal second readout period described above. Next, if the voltage detection signal Spos maintains the second value (1) during the sleep period without switching to the first value (0), it means that if the pulse control circuit 450 does not output the pulse signal, the first voltage Vpos can no longer meet the current load requirements, so the pulse control circuit 450 also needs to output the pulse signal with the higher frequency/larger duty cycle during the sleep period.

That is to say, when the pulse control circuit 450 needs to output the pulse signal and how to output the pulse signal can be controlled by the voltage detection signal Spos. As long as the potential of the first voltage Vpos is found to be too small, the potential of the first voltage Vpos needs to be increased according to the voltage detection signal Spos as quickly as possible, even if it is currently in a preset sleep period, so that the potential of the first voltage Vpos reaches an appropriate level as quickly as possible.

In the embodiments described above in conjunction with FIGS. 5 and 6, only two types of pulse signals are involved, namely the pulse signal corresponding to the first value of the voltage detection signal Spos (having a first frequency and/or a first duty cycle) and the pulse signal corresponding to the second value of the voltage detection signal Spos (having a second frequency and/or a second duty cycle). In other embodiments, more types of pulse signals may be generated according to a change direction of the first voltage Vpos.

In other embodiments, even if the value of the voltage detection signal Spos does not change, the frequency/duty cycle of the pulse signal can be adjusted differently according to the specific voltage range in which the potential of the first voltage Vpos is located and the change direction, so that the first Voltage Vpos better matches the current load requirements and reduces power consumption as much as possible. The voltage detection circuit 446 generates the voltage detection signal based at least in part on a comparison result between the potential of the first voltage Vpos and at least two preset voltage thresholds.

For example, the voltage detection circuit 446 may still employ a hysteresis comparator circuit to output the voltage detection signal Spos, and the pulse control circuit 450 may generate the pulse signal based on a determination of whether the first voltage Vpos is increasing or decreasing, and based on a comparison of the potential of the first voltage Vpos with the at least two preset voltage thresholds.

For example, when the first voltage Vpos is not in an increasing process starting from a potential less than the minimum voltage threshold Vthmin, and the potential of the first voltage Vpos is between the minimum voltage threshold Vthmin and the maximum voltage threshold Vthmax, the voltage detection signal Spos having the first value is generated; when the potential of the first voltage Vpos is less than the minimum voltage threshold Vth1, the voltage detection signal Spos having the second value is generated; when the first voltage Vpos is in the above-mentioned increasing process from a potential less than the minimum voltage threshold Vthmin and the potential of the first voltage Vpos is greater than or equal to the minimum voltage threshold Vthmin and less than the maximum voltage threshold Vthmax, the voltage detection signal Spos having the second value is generated; when the potential of the first voltage Vpos is greater than or equal to the maximum voltage threshold Vthmax, the voltage detection signal Spos having the first value is generated.

In addition, in response to the voltage detection signal Spos being the first value (0) during a readout period, the pulse control circuit 450 outputs the pulse signal with a corresponding frequency and/or duty cycle according to the voltage range in which the potential of the first voltage Vpos is located, and in response to the voltage detection signal Spos being the first value during a sleep period, the pulse control circuit 450 does not output the pulse signal during the sleep period. In response to the voltage detection signal Spos being the second value, the pulse control circuit 450 outputs the pulse signal with a corresponding frequency and/or duty cycle according to the voltage range in which the potential of the first voltage Vpos is located, regardless of the readout period or the sleep period. For example, when the value of the voltage detection signal is the same, the frequency or duty cycle of the pulse signal corresponding to the voltage range including the larger potential is smaller (assuming that the smaller the duty cycle is, the smaller the potential of the output first voltage is, and the more slowly the potential of the first voltage appears to increase when provided to the load).

That is to say, similar to the above, as long as the potential of the first voltage Vpos is found to be too small, the potential of the first voltage Vpos needs to be increased according to the voltage detection signal Spos as quickly as possible, even if it is currently in a preset sleep period, so that the potential of the first voltage Vpos reaches an appropriate level as quickly as possible.

FIG. 7 shows a schematic diagram of changes in the voltage detection signal Spos and the pulse signal PULSEpos as the first voltage Vpos changes in the presence of the first voltage threshold Vth1, the second voltage threshold Vth2 and the third voltage threshold Vth3.

As shown in FIG. 7, the clock generator 420 or the pulse control circuit 450 may divide time domain into a first period (readout period or active period) and a second period (sleep period) alternately.

Because the first-stage voltage conversion circuit 442 needs to output the first voltage Vpos during the readout period, the pulse control circuit 450 outputs the pulse signal PULSEpos for the first-stage voltage conversion circuit 442 to output the first voltage Vpos. During the ordinal first readout period (Readout) shown in FIG. 7, the load power requirement is not high, that is, it is not in a high load power scene, the first voltage Vpos may fluctuate slightly between the first voltage threshold Vth1 and the third voltage threshold Vth3 and not in an increasing process from a potential smaller than the first voltage threshold Vth1, so the voltage detection signal Spos has the first value (0). The clock signal output by the pulse control circuit 450 has a first frequency corresponding to the first value (0), for example, the frequency code Rpos of the first frequency is 3, where the larger the frequency code value, the larger the frequency.

Then, during the ordinal second sleep period (Suspend) after the ordinal first readout period shown in FIG. 7, the pulse control circuit 450 does not output the pulse signal, and the first voltage Vpos output by the first-stage voltage conversion circuit 442 will decrease slightly, but because the load power requirements are not high, the decrease magnitude is not large, so that the potential of the first voltage Vpos is still between the first voltage threshold Vth1 and the third voltage threshold Vth3, and is not in the increasing process from a potential smaller than the first voltage threshold Vth1, so the voltage detection signal Spos still has the first value.

Then, at time ts0, the ordinal second readout period (Readout) starts. In the first sub-period ts0-ts1 of the ordinal second readout period (Readout), even if the pulse control circuit 450 is still outputting the pulse signal, due to the high load power requirements, for example, the display picture with higher brightness needs to be displayed. At this time, because the pulse signal is still of a low frequency, the potential of the first voltage Vpos output by the first-stage voltage conversion circuit 442 is still decreasing. When the first voltage Vpos is decreasing, but is still greater than or equal to the minimum first voltage threshold Vth1, the voltage detection signal Spos has the first value (0). When the potential of the first voltage Vpos decreases to less than the minimum first voltage threshold Vth1 at time ts1, the voltage detection signal Spos switches to the second value (1). The pulse control circuit 450 changes the frequency of the pulse signal PULSEpos after the current pulse cycle of the pulse signal PULSEpos ends. Therefore, as shown in FIG. 7, within the second sub-period ts1-ts2 of the ordinal second readout period (Readout), even if the potential of the first voltage Vpos has decreased to less than the first voltage threshold Vth1, because the current pulse cycle has not yet ended, the pulse control circuit 450 does not generate the pulse signal with a different frequency until the current pulse cycle ends at time ts2.

During the third sub-period ts2-ts3 of the ordinal second readout period (Readout), in response to the first voltage Vpos increasing from a potential less than the first voltage threshold Vth1 and less than the second voltage threshold Vth2, the voltage detection signal Spos remains at the second value (1), and the pulse signal PULSEpos has a second frequency, where the second frequency is greater than the first frequency of the pulse signal in the ordinal first readout period (Readout). At time ts3, the potential of the first voltage Vpos increases to the second voltage threshold Vth2. At this time, because the potential of the first voltage Vpos is still less than the maximum third voltage threshold Vth3, the voltage detection signal Spos still remains at the second value (1).

In addition, because the potential of the first voltage VPos needs to be increased as quickly as possible during the increase process less than the second voltage threshold Vth2, then, during the increase process corresponding to the third sub-period ts2-ts3, the second frequency of the pulse signal can be relatively high, for example, the frequency code of the second frequency is 7.

Then, during the fourth sub-period ts3-ts4, at time ts3, the current pulse cycle of the pulse signal ends, and at this time the potential of the first voltage Vpos is still less than the maximum third threshold voltage Vth3, so the voltage detection signal Spos still remains at the second value (1), and the pulse signal PULSEpos has the third frequency. Because at this stage, the potential of the first voltage Vpos is closer to the third threshold voltage Vth3, the third frequency can be less than the second frequency, for example, the frequency code of the third frequency is 5 so that power consumption can be reduced, but the third frequency is still greater than the first frequency. At time ts4, the potential of the first voltage Vpos increases to the third threshold voltage Vth3, so the voltage detection signal Spos switches to the first value (0) again.

At time ts4, although the potential of the first voltage Vpos reaches the third voltage threshold Vth3, because the current pulse cycle has not ended, the pulse control circuit 450 does not generate the pulse signal with a different frequency, and the potential of the first voltage Vpos continues to increase, until the current pulse cycle ends at time ts5. Thereafter, at time ts5, because the potential of the first voltage Vpos is greater than the third voltage threshold Vth3, and is greater than the potential of the first voltage within the ordinal first readout period (Readout)Vpos which is between the first voltage threshold Vth1 and the third voltage threshold Vth3, the pulse control circuit 450 can generate the pulse signal with a fourth frequency that is less than the first frequency. For example, the frequency code of the fourth frequency can be 1, so the power consumption can be reduced compared to the case where the first frequency is used. Thereafter, under the control of the pulse signal of the fourth frequency, and considering the low load requirements, the potential of the first voltage Vpos decreases slightly, and the pulse control circuit 450 continues to output the pulse signal with a corresponding frequency according to the detection result of the potential of the first voltage Vpos and the change direction of the first voltage Vpos.

Of course, if the potential of the first voltage Vpos is adjusted through duty cycle adjustment, the operation process is similar.

Therefore, through the improved CMOS image sensor described above in conjunction with FIGS. 4, 5, 6 and 7, a voltage detection circuit is used to detect the first voltage Vpos output by the first-stage voltage conversion circuit in the power system, and based on the result of comparing the first voltage Vpos with one or more voltage thresholds, a voltage detection signal is generated and output to the pulse control circuit to adjust the frequency and/or duty cycle of the pulse signal, thereby changing a potential of the first voltage Vpos. Therefore, when the pixel circuit is sunk by loads too deeply in a specific scene such as high load power, the voltage detection signal Spos can be used to control the pulse control circuit to generate a pulse signal with a higher frequency and/or an adjusted duty cycle to be provided to the power system, to ensure the potential of the first voltage Vpos.

In addition, during the preset readout period (i.e., the stage of reading out the pixel voltage), if the load power is within the normal range (i.e., the voltage Vpos will not be excessively sunk), the CMOS image sensor can maintain a pulse signal having a lower frequency/smaller duty cycle (assuming that the smaller the duty cycle, the smaller the potential of the output first voltage Vpos) to achieve the purpose of low power consumption, and it is not necessary to constantly maintain the pulse signal at a high frequency/large duty cycle in order to meet the possible high load power requirements as shown in the FIG. 3. During the preset sleep period, as long as the first voltage Vpos is too low, the voltage detection signal Spos generated by the voltage detection circuit is used to adjust the starting time of the pulse signal, that is, the pulse signal can still be generated during the sleep period, and the first voltage Vpos can be adjusted in time to avoid insufficient first voltage Vpos, thus avoiding poor performance of the CMOS image sensor, such as failure when presenting the display picture.

In addition, the power system of the present disclosure includes two stages of voltage conversion circuits, which can have a higher Power Supply Rejection Ratio (PSRR) (about 110dB) of the pixel voltage output by the pixel circuit 112 to the input voltage AVDD, and can adaptively adjust the timing according to scene changes to achieve optimized low power consumption characteristics.

In the embodiments of the present disclosure, the implementation of the pixel circuit and the power system is not limited, and various changes are possible.

According to another aspect of the present disclosure, a sensing circuit for a Complementary Metal Oxide Semiconductor (CMOS) pixel array is also provided.

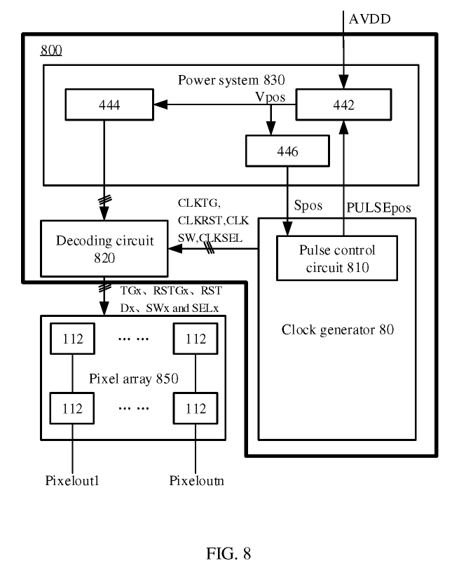

FIG. 8 illustrates a schematic structural diagram of a sensing circuit according to an embodiment of the present disclosure. The CMOS pixel array 850 to which it is applied is also shown for clearer description.

For example, the CMOS pixel array 850 may be as pixel array 110 previously described with reference to FIG. 1 or pixel array 410 described with reference to FIG. 4, and may include a plurality of pixel circuits arranged in an array.

As shown in FIG. 8, the sensing circuit 800 may include: a pulse control circuit 810, a decoding circuit 820, and a power system 830.

The pulse control circuit 810 is configured to generate, based on a voltage detection signal, clock signals for a decoding process. The pulse control circuit 810 may also be included in a clock generator 80, or be independent of the clock generator 80.

The decoding circuit 820 is configured to decode based on the clock signals, and the power system 830 is configured to provide the voltage detection signal to the pulse control circuit 810 and one or more voltages to the decoding circuit 820. The decoding circuit 820 may generate pixel driving signals for controlling each pixel circuit in the CMOS pixel array based on the decoding result and using the one or more voltages.

The power system 830 may be a power system as previously described with reference to FIGS. 4, 5, 6, and 7, which may include a first-stage voltage conversion circuit 442, a second-stage voltage conversion circuit 444, and a voltage detection circuit 446.

The first-stage voltage conversion circuit 442 may be configured to convert an input voltage to a first voltage in response to a pulse signal from the pulse control circuit 810, and the second-stage voltage conversion circuit 444 may be configured to convert the first voltage to one or more second voltages, and the one or more second voltages are used to provide the required voltages for the decoding circuit 830 to operate.

The voltage detection circuit 446 may be configured to generate a voltage detection signal based on the first voltage, where the voltage detection signal is used by the pulse control circuit 810 to generate the pulse signal. The pulse signal may be a clock signal, so the potential of the first voltage may be changed by changing the frequency of the clock signal; in addition, the pulse signal may be a PWM signal or a PFM signal, etc., so the potential of the first voltage may be changed by changing the frequency and/or duty cycle of the pulse signal.

The specific structure of the power system 830 and its interaction logic with circuit components such as the pulse control circuit 810 can be as described previously with reference to FIGS. 4, 5, 6 and 7, and the description will not be repeated here.

The above-mentioned CMOS image sensor including the pixel array and the sensing circuit not including the pixel array can be implemented in an integrated circuit. The above-mentioned power system and its unit components are analog circuits in the integrated circuit or mixed circuits of logic circuits and analog circuits. The above-mentioned pulse control circuit, clock generator and decoding circuit are logic circuits in the integrated circuit, and the functions related to the logic circuits can be implemented as hardware using hardware description languages (such as Verilog HDL or VHDL) or other suitable programming languages. It will be apparent to those skilled in the art that various modifications and variations can be made in the structure of the disclosed embodiments without departing from the scope or spirit of the disclosure. In view of the foregoing, it is intended that the present disclosure cover modifications and variations of this disclosure provided they come within the scope of the appended claims and their equivalents.

1. A power system for a Complementary Metal Oxide Semiconductor (CMOS) image sensor, comprising:
a first-stage voltage conversion circuit configured to convert an input voltage into a first voltage in response to a pulse signal;
a second-stage voltage conversion circuit configured to convert the first voltage into one or more second voltages for providing voltages required for operations of the CMOS image sensor; and
a voltage detection circuit configured to generate a voltage detection signal based on the first voltage, wherein the voltage detection signal is used by a pulse control circuit to generate the pulse signal.

2. The power system according to claim 1, wherein the voltage detection circuit is configured to:
generate the voltage detection signal based on a comparison result of a potential of the first voltage with at least one preset voltage threshold,
wherein the voltage detection signal has a first value and a second value, and compared to the first value, the second value corresponds to a higher frequency of the pulse signal, and/or the second value corresponds to a duty cycle of the pulse signal based on which the first voltage output by the first-stage voltage conversion circuit has a higher potential.

3. The power system according to claim 2, wherein the at least one preset voltage threshold comprises a first voltage threshold, and wherein the voltage detection circuit is configured to:
when the potential of the first voltage is greater than or equal to the first voltage threshold, generate the voltage detection signal having the first value; and
when the potential of the first voltage is less than the first voltage threshold, generate the voltage detection signal having the second value.

4. The power system according to claim 2, wherein the at least one preset voltage threshold comprises a first voltage threshold and a second voltage threshold greater than the first voltage threshold, and wherein the voltage detection circuit is configured to:
generate the voltage detection signal having the first value, when the first voltage is not in an increasing process starting from a potential less than the first voltage threshold and the potential of the first voltage is between the first voltage threshold and the second voltage threshold;
generate the voltage detection signal having the second value, when the potential of the first voltage is less than the first voltage threshold;
generate the voltage detection signal having the second value, when the first voltage is in the increasing process and the potential of the first voltage is greater than or equal to the first voltage threshold and less than the second voltage threshold; and
generate the voltage detection signal having the first value, when the potential of the first voltage is greater than or equal to the second voltage threshold.

5. The power system according to claim 3, wherein the CMOS image sensor is preset to operate alternately in a readout period and a sleep period, and wherein:
in response to the voltage detection signal being the first value in the readout period, the pulse control circuit outputs the pulse signal having a first frequency and/or a first duty cycle, and in response to the voltage detection signal being the first value in the sleep period, the pulse control circuit does not output the pulse signal in the sleep period; and
in response to the voltage detection signal being the second value, the pulse control circuit outputs the pulse signal having a second frequency and/or a second duty cycle regardless of the readout period or the sleep period,
wherein the second frequency is greater than the first frequency, and/or the second duty cycle causes the first-stage voltage conversion circuit to output the first voltage having a higher potential than the first duty cycle.

6. The power system according to claim 2, wherein the at least one preset voltage threshold comprises at least two preset voltage thresholds,
wherein the voltage detection circuit is configured to generate the voltage detection signal based on a comparison result of the potential of the first voltage with the at least two preset voltage thresholds and a change direction of the potential of the first voltage.

7. The power system according to claim 6, wherein,
when the first voltage is not in an increasing process starting from a potential less than a minimum voltage threshold of the at least two preset voltage thresholds, and the potential of the first voltage is between the minimum voltage threshold and a maximum voltage threshold of the at least two preset voltage thresholds, the voltage detection signal has the first value;
when the potential of the first voltage is less than the minimum voltage threshold, the voltage detection signal has the second value;
when the first voltage is in the increasing process and the potential of the first voltage is greater than or equal to the minimum voltage threshold and less than the maximum voltage threshold, the voltage detection signal has the second value; and
when the potential of the first voltage is greater than or equal to the maximum voltage threshold, the voltage detection signal has the first value.

8. The power system according to claim 7, wherein the CMOS image sensor is preset to operate alternately in a readout period and a sleep period, and wherein:
in response to the voltage detection signal being the first value during the readout period, the pulse control circuit outputs the pulse signal having a corresponding frequency and/or duty cycle according to the voltage range in which the potential of the first voltage is located, and in response to the voltage detection signal being the first value during the sleep period, the pulse control circuit does not output the pulse signal during the sleep period, and
in response to the voltage detection signal being the second value, the pulse control circuit outputs the pulse signal with a corresponding frequency and/or duty cycle according to the voltage range in which the potential of the first voltage is located, regardless of the readout period or the sleep period.

9. The power system according to claim 7, wherein the at least two preset voltage thresholds comprise a first voltage threshold, a second voltage threshold and a third voltage threshold in an increasing order, and wherein:
when the first voltage is not in an increasing process starting from a potential less than the first voltage threshold, and the potential of the first voltage is greater than or equal to the first voltage threshold and less than the third voltage threshold, the voltage detection signal has the first value, and the pulse signal has a first frequency and/or a first duty cycle;
when the potential of the first voltage is less than the first voltage threshold, or when the first voltage is in the increasing process and the potential of the first voltage is greater than or equal to the first voltage threshold and less than the second voltage threshold, the voltage detection signal has the second value, and the pulse signal has a second frequency and/or a second duty cycle;
when the first voltage is in the increasing process and the potential of the first voltage is greater than or equal to the second voltage threshold and less than the third voltage threshold, the voltage detection signal has the second value, and the pulse signal has a third frequency and/or a third duty cycle;
when the potential of the first voltage is greater than or equal to the third voltage threshold, the voltage detection signal has the first value, and the pulse signal has a fourth frequency and/or a fourth duty cycle;
wherein the fourth frequency, the first frequency, the third frequency, and the second frequency are in an increasing order, and/or potentials of the first voltage generated based on the fourth duty cycle, the first duty cycle, the third duty cycle, and the second duty cycle are in an increasing order.

10. The power system according to claim 1, wherein, in the case where the pulse control circuit determines that a frequency and/or duty cycle of the pulse signal needs to be changed based on the voltage detection signal, the pulse control circuit changes the frequency and/or duty cycle of the pulse signal only after a current pulse cycle of the pulse signal ends.

11. The power system according to claim 1, wherein the first-stage voltage conversion circuit includes a charge pump circuit, and wherein the pulse signal is a clock signal for voltage control; or
the first-stage voltage conversion circuit comprises a direct-current (DC)-DC converter, and wherein the pulse signal is a pulse width modulated (PWM) signal or a pulse frequency modulated (PFM) signal.

12. The power system according to claim 1, wherein the second-stage voltage conversion circuit includes one or more sub-circuits, and each sub-circuit is a linear regulator and is configured to generate a corresponding second voltage.

13. The power system according to claim 1, wherein the pulse control circuit is included in the power system or is independent of the power system.

14. A Complementary Metal Oxide Semiconductor (CMOS) image sensor, comprising:
a pixel array comprising a plurality of pixel circuits arranged in an array;
a pulse control circuit configured to generate, according to a voltage detection signal, clock signals for a decoding process;
a decoding circuit configured to decode based on the clock signals; and
the power system as claimed in claim 1, configured to provide the voltage detection signal to the pulse control circuit and to provide the one or more second voltages to the decoding circuit,
wherein the decoding circuit generates, based on a decoding result and using the one or more second voltages, pixel driving signals for controlling the pixel circuits.

15. A sensing circuit for a Complementary Metal Oxide Semiconductor (CMOS) pixel array comprising a plurality of pixel circuits arranged in an array, the sensing circuit comprising:
a pulse control circuit configured to generate, according to a voltage detection signal, clock signals for a decoding process;
a decoding circuit configured to decode based on the clock signals; and
the power system as claimed in claim 1, configured to provide the voltage detection signal to the pulse control circuit and to provide the one or more second voltages to the decoding circuit,
wherein the decoding circuit generates, based on a decoding result and using the one or more second voltages, pixel driving signals for controlling the pixel circuits.
